(19) United States
(12) Patent Application Publication
(10) Pub. No.: US 2010/0176203 A1
(43) Pub. Date: Jul. 15, 2010

(54) METHOD FOR GENERATING A PROFILE FOR THE PERSONALISATION OF AN ELECTRONIC ENTITY AND ASSOCIATED SYSTEM

(75) Inventors: Régis Mounier, Boulogne-Billancourt (FR); Jean-Marc Louis, Herblay (FR)

Correspondence Address: YOUNG & THOMPSON, 209 Madison Street, Suite 500, Alexandria, VA, 22314, US

(73) Assignee: OBERTHUR TECHNOLOGIES, Paris (FR)

(21) Appl. No.: 12/160,891

(22) PCT Filed: Jan. 12, 2007
(86) PCT No.: PCT/FR2007/000056

§ 371 Date: Jul. 15, 2008

(30) Foreign Application Priority Data
Jan. 16, 2006 (FR) 0650137

(51) Int. Cl. G06K 19/00; G06K 19/07

(52) U.S. Cl. 235/492; 235/487

(57) ABSTRACT

A method for generating a profile for the personalization of an electronic entity, includes the following steps: selection (E101) of at least one application from a pre-defined list of applications; configuration (E103) of parameters associated with the selected application; selection (E104) of a material platform from a list of compatible platforms determined according to the selected applications and configured parameters; and obtention (E105) of the personalization profile according to the selected applications, configured parameters and selected platform.

The invention concerns a method for generating a profile for the personalization of an electronic entity and a system for generating such profiles.

The use of an electronic entity in a particular application context implies storage in the electronic entity of data and/or programs liable to be used in that context.

This is why use is frequently made, in particular for portable electronic entities (such as microcircuit cards, for example), of a personalization step in which data specific to it is written into a memory of the electronic entity, such as the identity of the cardholder, for example.

This personalization data is generally stored in a non-volatile rewritable memory (for example an electrically erasable and programmable read only memory (EEPROM)), particularly suitable for storing this type of data, which varies from one card to another.

On the other hand, the overall structure of the personalization data to be written into this memory is common to a set of cards of the same type and thus contributes to defining a personalization profile associated with that card type.

A personalization profile is thus a set of data associated with a card type and which defines general personalization characteristics of cards of that type, such as the structure of the data (possibly including a program) and the common data to be written into the electronic entity during personalization, or physical personalization data (characters to be embossed, coding of the magnetic stripe, etc.) or graphical personalization data (logo to be printed on the surface of the card, etc.).

The definition of a personalization profile is particularly complex since it must consistently respect a set of criteria linked to the structure and to the future use of the electronic entity, for example existing standards (e.g. GSM in telephony or EMV in the banking field) and applications (e.g. VISA, MASTERCARD), and the internal (hardware) organization of the electronic entity.

Such definitions are therefore conventionally onerous to define and the risk of error cannot be avoided even if the profile is defined by experienced staff.

To improve on this situation, the invention proposes a method of generating a profile for personalizing an electronic entity, characterized in that it includes the following steps:
choosing at least one application in a predefined list of applications;
configuring parameters associated with the chosen application;
selecting a hardware platform from a list of compatible platforms determined as a function of the applications chosen and the parameters configured;
obtaining the personalization profile as a function of the applications chosen, the parameters configured and the platform selected.

This simplifies generating the personalization profile data. The inventors have noted that the choice of the application considerably limits the possible solutions for the other personalization configuration data, which considerably simplifies generating configuration profile data and makes it possible to generate it interactively, for example by means of a data processing system.

A more functional approach also results, enabling concentration on the choices of the client, and minimizing the technical knowledge necessary for generating the personalization profile (especially in the field of the microcircuit card).

Finally, the consistency of all the elements taken into account to define of the profile is ensured since the compatibility of the applications, their configuration and the platform used follows inevitably from the proposed solution.

For example, the configuration step can include a step of selecting a value in a predefined list of possible values determined as a function of the application chosen or a step of entering a parameter in an entry screen determined as a function of the application chosen.

The configuration step can moreover use a symbolic representation (for example an appropriate identifier) of the binary data defining said parameters, which simplifies their manipulation by non-experts.

Alternatively, or for only some parameters, the configuration step can use a hexadecimal representation of the binary data defining said parameters, that representation being sometimes that best known to users of the system.

The configuration step includes a step of defining a size of a memory space of the electronic entity, for example.

To improve further the overall consistency of the profile, there may additionally be a step of verifying the consistency of the parameters configured, for example against a predetermined standard.

The application considered here uses functions conforming to a predefined standard, for example, such as a standard for mobile telephone cards or a standard for bank cards.

It can equally be an application for making the electronic entity secure.

The platform previously referred to is defined by the combination of a component and an operating system, for example.

In practice, the electronic entity can be portable, as in the case of a microcircuit card.

The invention also proposes a method for personalizing an electronic entity, characterized by the following steps:
generating a personalization profile by the above method;
integrating holder data into the profile generated;
writing the profile incorporating the holder data into a memory of the electronic entity.

The invention further proposes a system for generating a profile for personalizing an electronic entity, characterized in that it includes means for choosing at least one application in a predefined list of applications, means for configuring parameters associated with the application chosen, means for selecting a hardware platform from a list of compatible platforms determined as a function of the applications chosen and the parameters configured, and means for generating the personalization profile as a function of the applications chosen, the parameters configured and the platform selected.

Such systems can optionally further include means for implementing the various features that can be envisaged for the profile generation method referred to above.

Other features and advantages of the invention will become apparent in the light of the following description, given with reference to the appended drawings, in which:

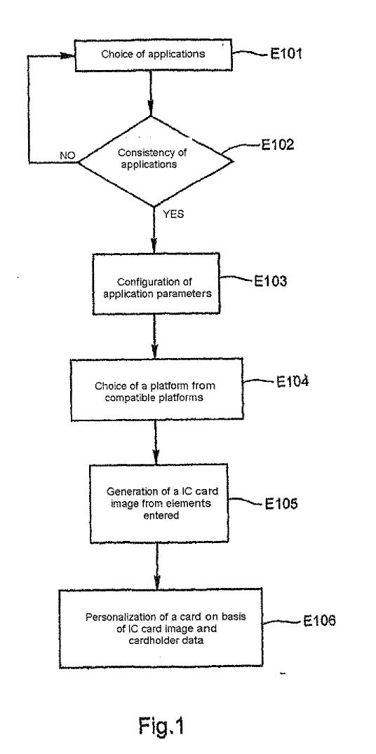

FIG. 1 shows the essential steps of one example of a microcircuit card personalization method of the invention;

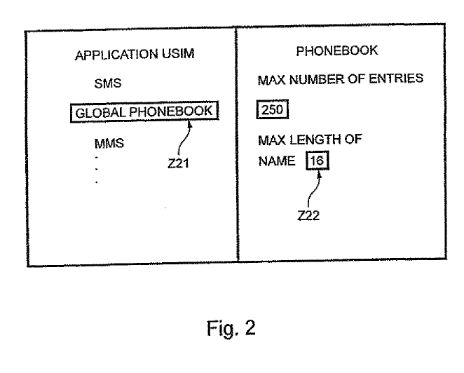

FIG. 2 represents a screen for configuring an application in the field of mobile telephones;

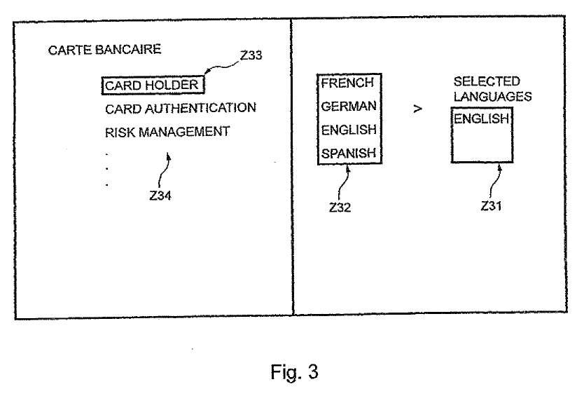

FIG. 3 represents a screen for configuring an application in the field of bank cards;

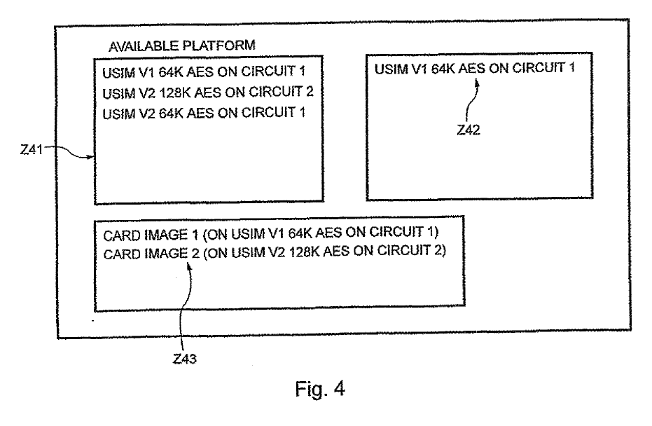

FIG. 4 represents a screen for selecting a platform from a list of compatible platforms.

FIG. 1 shows the essential steps of an example of a method for personalizing microcircuit cards in accordance with the invention. Such methods are implemented by means of a personal computer (PC) type data processing system in an interactive environment, for example.

The method begins with a step E101 of choosing applications that the cards to be personalized will have to be able to implement. Several applications are generally selected at this stage, but this could be limited to a single application in some cases, of course.

Here the applications are chosen from a predefined list, presented interactively to the user of the system by means of a drop-down menu, for example.

The system (i.e. generally the software that controls its execution) then verifies in the step E102 the consistency of the selected applications and, in the event of lack of consistency, returns to the step E101 (and for example displays a message reporting the inconsistency), in order to ensure that the chosen applications are consistent.

If the chosen applications do not generate any inconsistency, the step E102 is followed by a step E103 of configuring the parameters relating to each of the applications previously chosen.

FIG. 2 shows an example of configuring the USIM application referred to above in the field of mobile telephones.

In this example, the “Phonebook” is configured by selecting the “Global Phonebook” parameters (the area Z21 of the screen showing this is then highlighted) and by entering the phonebook parameters as defined in the corresponding mobile telephone standard (by entry on the screen represented in FIG. 2, specifically in the area Z22 of that screen).

Note that the screen shown by the system for entering parameters depends on the application chosen in the preceding step.

Thus a maximum number of entries in the phonebook equal to 250 is defined, for example, a maximum length of name equal to 16 bytes, etc.

This configuration in particular defines the size of the files for storing the phonebook in the microcircuit card (to be precise in the EEPROM memory of that card).

Default configurations can also be defined for each application.

The configuration step also includes a step of verifying the consistency of the information entered or selected, in particular to ensure conformance to the corresponding mobile telephone standards. Entering a parameter incompatible with the standard concerned generates an error message (for example entering a size of 888 bytes for the status reports of short message service (SMS) messages, the size of which cannot exceed 255 bytes).

FIG. 3 shows one example of configuring the “bank card” application.

In this example, the preferred language of the cardholder (area Z31 of the screen represented in FIG. 3) is determined by selecting it from a list of possible languages (area Z32). This function is configured by selecting the function (area Z33 highlighted) in a window (area Z34) representing the applications selected in the step E101.

Note here that the chosen preferred language is represented physically in the microcircuit card in binary form. The card itself does not include means for converting this representation into a symbolic (generally alphanumeric) representation. This is because it exchanges this value with the external environment only in binary form.

Thanks to the use of the interactive system of the invention, the graphical interface used represents this value in symbolic form (here by means of the alphanumeric characters forming the word “English”), for example thanks to using a table of correspondence between the binary representation and the symbolic representation stored in the profile generation system described here.

Alternatively, a hexadecimal representation of the binary data to be entered could be used.

The elements entered by the user in the step E101 of choosing applications and the step E103 of configuring them can then be stored, for example in the form of a database, which consequently gives a functional description of the personalization profile, independently of the hardware platform (i.e. components and operating systems) of the microcircuit card. Such databases can then be used to introduce identical functions on another hardware platform.

The database uses an object type structure, for example, in which each choice of the user (choice of application, entry and selection of configuration data, etc.) is stored as an instance of an object of one of the predefined classes.

Thanks in particular to the inheritance mechanism, duplication of unnecessary codes is avoided, through defining general classes that describe a configuration profile and functions common to numerous applications, and by defining classes that describe functions specific to a given application inheriting more general class attributes.

Once the functional definition has been determined (applications chosen in the step E101 and configuration thereof in the step E103), in a step E104 the interactive system prompts selection of the platform for which the personalization is intended from a list of platforms compatible with the functional definition produced in the preceding steps, as shown in FIG. 4.

Some platforms can be unsuited to the functions required by the functional definition (for example because of too small a memory capacity or the impossibility of implementing a particular application, such as JavaCard).

The system for generating a personalization profile proposed here stores the characteristics specific to each platform used and can thus generate the list of platforms adapted to implement the functional definition established in the steps E101 and E103, i.e. compatible therewith, and display that list (area Z41 in FIG. 4).

The platforms are defined, for example, by associating a component (generally an integrated circuit of the card to be personalized) and an operating system (generally called “mask” in the field of microcircuit cards).

There may be displayed in association with each compatible platform information intended to facilitate the choice of a platform by the user, such as (for each platform) information on cost, reliability of supply, previous use, for example.

The user can thus choose the platform most appropriate to the preceding functional definition, with no risk of incompatibility. The platform selected is displayed in a dedicated window, for example (here the window Z42 in FIG. 4).

Once the user has confirmed the choice of platform (for example by selecting a virtual button), in the step E105 the system generates, on the basis of elements provided by the user in previous steps, the IC card image, which therefore defines the data in the EEPROM, with the exception of the elements specific to each cardholder, stored in the form of an object, for example (in the object-oriented programming sense).

In particular it represents the file structure of the EEPROM (conforming to the ISO standard 7816) as well as the content and the size of the files that were determined during generation of the personalization profile.

In addition to the description of the files and their structure, the IC card image contains all the other information defining the EEPROM of the card (with the exception of the data that is different for each cardholder), such as the memory areas containing variables, and their value.

These variables are stored in tag length value (TLV) form, for example, i.e. the identifier, the length and the value in succession. The aforementioned configuration steps can generate data in this form, the value being fixed in this step or defined afterwards according to whether or not it is common to all cardholders.

For greater flexibility, an interactive screen can be provided, for example once the IC card image has been generated, to enable modification of some of the elements constituting the IC card image in hexadecimal representation. Such modifications will generally not be necessary since all the elements that determine the IC card image are normally taken into account during preceding steps.

The various IC card images generated by the system are stored and displayed in a dedicated window (here Z43), for example.

The personalization profile determined in this way (formed of the IC card image, for example, and possibly other parameters linked to the physical appearance of the card, for example and entered during the step E103, for example) can be used to personalize microcircuit cards (step E106), integrating the data specific to each cardholder into the IC card image defined above (i.e. combining it therewith).

The embodiments referred to above constitute only possible embodiments of the invention, which is not limited to them.

1. Method of generating a profile for personalizing an electronic entity, characterized in that it includes the following steps:
choosing (E101) at least one application in a predefined list of applications;
configuring (E103) parameters associated with the chosen application;
selecting (E104) a hardware platform from a list of compatible platforms determined as a function of the applications chosen and the parameters configured;
obtaining (E105) the personalization profile as a function of the applications chosen, the parameters configured and the platform selected.

2. Profile generation method according to claim 1, characterized in that the configuration step (E103) includes a step of selecting a value (Z31) in a predefined list of possible values (Z32) determined as a function of the application chosen.

3. Profile generation method according to claim 1, characterized in that the configuration step (E103) includes a step of entering a parameter in an entry screen (Z22) determined as a function of the application chosen.

4. Profile generation method according to claim 1, characterized in that the configuration step (E103) uses a symbolic representation (Z31) of the binary data defining said parameters.

5. Profile generation method according to claim 1, characterized in that the configuration step (E103) uses a hexadecimal representation of the binary data defining said parameters.

6. Profile generation method according to claim 1, characterized in that the configuration step (E103) includes a step of defining (Z22) a size of a memory space of the electronic entity.

7. Profile generation method according to claim 1, characterized by a step of verifying the consistency of the parameters configured.

8. Profile generation method according to claim 7, characterized in that the consistency of the parameters configured is verified against a predetermined standard.

9. Profile generation method according to claim 1, characterized in that the application uses functions conforming to a predefined standard.

10. Profile generation method according to claim 9, characterized in that the predefined standard is a mobile telephone card standard.

11. Profile generation method according to claim 9, characterized in that the predefined standard is a bank card standard.

12. Profile generation method according to claim 1, characterized in that the application is an application for making an electronic entity secure.

13. Profile generation method according to claim 1, characterized in that the platform is defined (Z41; Z42) by associating a component and an operating system.

14. Profile generation method according to claim 1, characterized in that the electronic entity is portable.

15. Profile generation method according to claim 14, characterized in that the electronic entity is a microcircuit card.

16. Method for personalizing an electronic entity, characterized by the following steps:
generating a personalization profile (E101, E103, E104, E105) by means of a method according to claim 1;
integrating holder data into the profile generated;
writing (E106) the profile incorporating the holder data into a memory of the electronic entity.

17. System for generating a profile for personalizing an electronic entity, characterized in that it includes:
means for choosing at least one application in a predefined list of applications;
means for configuring parameters associated with the application chosen;
means for selecting a hardware platform from a list of compatible platforms determined as a function of the applications chosen and the parameters configured;
means for generating the personalization profile as a function of the applications chosen, the parameters configured and the platform selected.

18. Profile generation method according to claim 2, characterized in that the configuration step (E103) includes a step of entering a parameter in an entry screen (Z22) determined as a function of the application chosen.

19. Profile generation method according to claim 2, characterized in that the configuration step (E103) uses a symbolic representation (Z31) of the binary data defining said parameters.

20. Profile generation method according to claim 2, characterized in that the configuration step (E103) uses a hexadecimal representation of the binary data defining said parameters.
